(19) United States
(12) Patent Application Publication
(10) Pub. No.: US 2012/0186953 A1
(43) Pub. Date: Jul. 26, 2012

(54) SWITCH-LOCK FITTING AND CONTROL DEVICE

(75) Inventor: Tatsuhiko Furukawa, Chiyoda-ku (JP)

(73) Assignee: MITSUBISHI ELECTRIC CORPORATION, Chiyoda-ku, Tokyo (JP)

(21) Appl. No.: 13/499,218

(22) PCT Filed: May 19, 2010
(86) PCT No.: PCT/JP2010/058455

§ 371 Date: Mar. 29, 2012

(30) Foreign Application Priority Data
Sep. 30, 2009 (JP) 2009-227574

(51) Int. Cl. H01H 3/20

(52) U.S. Cl. 200/43.21

(57) ABSTRACT

A switch-lock fitting that can fix an on/off state of a locker switch having both ends that alternately perform advancing and retracting movements with respect to a mounting surface and also enables easy confirmation of the on/off state includes: a fixing portion that is fixed on a switch mounting surface on which the locker switch having the both ends that alternately perform the advancing and retracting movements is mounted, and a movement restricting portion that can restrict the advancing and retracting movements of the locker switch by covering a retracted portion of the locker switch in a state where the fixing portion is fixed on the switch mounting surface.

### FIELD

The present invention relates to a switch-lock fitting that fixes an on/off state of a switch and a control device including the switch-lock fitting.

### BACKGROUND

A control device that controls a target to be controlled such as a robotic arm often includes a switch for switching a power source between on and off states.

With this control device, when maintenance check of the control target or the control device itself is performed, it is necessary to prevent the control target from working during the maintenance check to ensure safety of operators. Therefore, the maintenance check of the control target or the control device itself is performed after the power source is switched to the off state by the switch.

It is also desirable to prevent the switch in the off state from being erroneously switched to the on state during the maintenance check to further enhance the safety of the operators working for the maintenance check. For example, Patent Literature 1 discloses a technique for preventing an erroneous switching operation by covering a lever switch with a box-like body and locking the body. In addition, Patent Literature 2 discloses a technique for preventing an erroneous switching operation by restricting movement of a lever part of a lever switch in a direction along a switch mounting surface, for example.

### CITATION LIST

### Patent Literatures

Patent Literature 1: Japanese Patent Application Laid-open No. H11-054018
Patent Literature 2: Japanese Utility Model Laid-open No. 61-168522

### SUMMARY

### Technical Problem

However, because the lever switch is entirely covered with the box-like body according to the technique disclosed in Patent Literature 1, it is difficult to confirm an on/off state thereof and accordingly difficult to perform a maintenance check operation without any anxiety. Furthermore, in the technique disclosed in Patent Literature 2, the movement of the lever part of the lever switch in the direction along the switch mounting surface is restricted and therefore it is difficult to secure fixation of an on/off state of a switch (hereinafter, referred to as “locker switch”) having both ends that alternately perform advancing and retracting movements with respect to the mounting surface.

The present invention has been achieved in view of the above-mentioned circumstances, and an object of the invention is to provide a switch-lock fitting that can fix an on/off state of a locker switch having both ends that alternately perform advancing and retracting movements with respect to a mounting surface and that also enables easy confirmation of the on/off state.

### Solution to Problem

In order to solve the above-mentioned problems and achieve the object, the present invention provides a switch-lock fitting comprising: a fixing portion that is fixed on a switch mounting surface on which a locker switch having both ends that alternately perform advancing and retracting movements is mounted; and a movement restricting portion that can restrict the advancing and retracting movements of the locker switch by covering a retracted portion of the locker switch in a state where the fixing portion is fixed on the switch mounting surface.

### Advantageous Effects of Invention

According to the present invention, a retracted portion of a locker switch can be covered to fix an on/off state and also the on/off state can be easily confirmed.

### BRIEF DESCRIPTION OF DRAWINGS

FIG. 1 is an external perspective view showing a schematic configuration of a control device including a switch-lock fitting according to a first embodiment of the present invention.

FIG. 2 is a cross-sectional view of part of a locker switch.

FIG. 3 is an enlarged partial front view of part of a locker switch on a switch mounting surface.

FIG. 4 includes external perspective views showing a schematic configuration of the switch-lock fitting.

FIG. 5 is a front view showing the switch-lock fitting in a state where a locking unit is locked.

FIG. 6 is a front view showing a switch-lock fitting in which a locking-unit restricting portion is not formed, as a comparative example.

FIG. 7 is a front view showing a switch-lock fitting in which a locking-unit restricting portion is not formed, as a comparative example.

FIG. 8 is an enlarged partial front view showing a state where a switch-lock fitting is screw-fixed using an on/off-fixing fixation hole.

FIG. 9 is an enlarged partial front view showing a state where a switch-lock fitting is screw-fixed using an on/off-releasing fixation hole.

FIG. 10 is a chart showing a procedure of fixing a locker switch in an off state by using a switch-lock fitting.

FIG. 11 is an external perspective view showing a schematic configuration of a control device including a switch-lock fitting according to a second embodiment of the present invention.

FIG. 12 includes external perspective views showing a schematic configuration of the switch-lock fitting.

FIG. 13 is an enlarged partial front view of part of a locker switch on a switch mounting surface.

FIG. 14 is an enlarged partial front view showing a state where the switch-lock fitting is screw-fixed using an on/off-fixing fixation hole.

FIG. 15 is an enlarged partial front view showing a state where the switch-lock fitting is screw-fixed using an on/off-releasing fixation hole.

FIG. 16 is a chart showing a procedure of fixing a locker switch in an off state by using the switch-lock fitting.

### DESCRIPTION OF EMBODIMENTS

Now embodiments of a switch-lock fitting according to the present invention will be described below in detail with reference to the drawings. Note that the present invention is not limited to these embodiments.

### First Embodiment

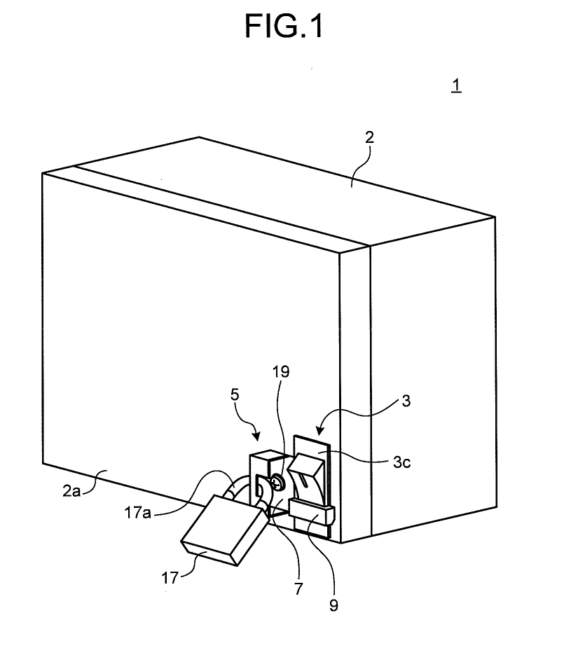

FIG. 1 is an external perspective view of a schematic configuration of a control device including a switch-lock fitting according to a first embodiment of the present invention. A control device 1 is intended to control a control target, such as a robotic arm or a processing device, connected to the control device 1. The control device 1 is configured to include a box 2 as a main body and a switch-lock fitting 5. A locker switch 3 is mounted on a switch mounting surface 2a, which is a front surface of the box 2. The locker switch 3 is a power switch for switching a power source of the control device 1 between on and off states.

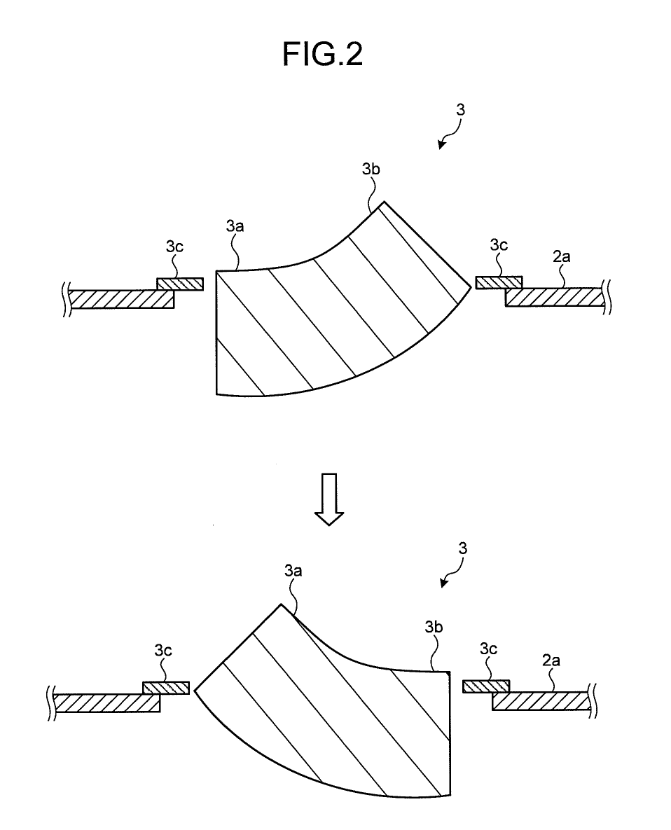

FIG. 2 is a cross-sectional view of part of the locker switch 3. As shown in FIG. 2, the locker switch 3 has both ends that alternately perform advancing and retracting movements with respect to the switch mounting surface 2a. When one end 3a of the locker switch 3 is brought into a retracted state and the other end 3b is brought into an advanced state, the power source of the control device 1 is turned on. On the other hand, when the other end 3b of the locker switch 3 is brought into a retracted state and the one end 3a is brought into an advanced state, the power source of the control device 1 is turned off. This means that a user of the control device 1 presses down one of the both ends of the locker switch 3, being in the advanced state, thereby to make a switching operation between the on and off states.

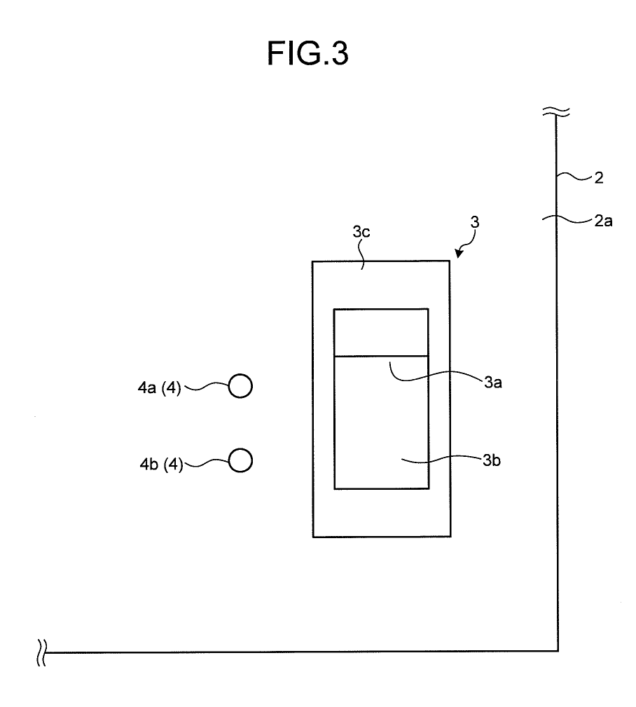

FIG. 3 is an enlarged partial front view of part of the locker switch 3 on the switch mounting surface 2a. As shown in FIG. 3, fixation holes 4 for screw-fixing the switch-lock fitting 5 are formed in the switch mounting surface 2a. Two fixation holes 4 are formed at a side of the other end 3b of the locker switch 3 to be juxtaposed in parallel to a longitudinal direction of the locker switch 3. An on/off-fixing fixation hole 4a, that is one of the two fixation holes 4, is used to fix the locker switch 3 in the off state. An on/off-releasing fixation hole 4b, which is the other one of the two fixation holes 4, is used to bring the locker switch 3 into a released state in which the switching between the on and off states is allowed.

Details of fixation of the switch-lock fitting 5 using the on/off-fixing fixation hole 4a and fixation of the switch-lock fitting 5 using the on/off-releasing fixation hole 4b are described later.

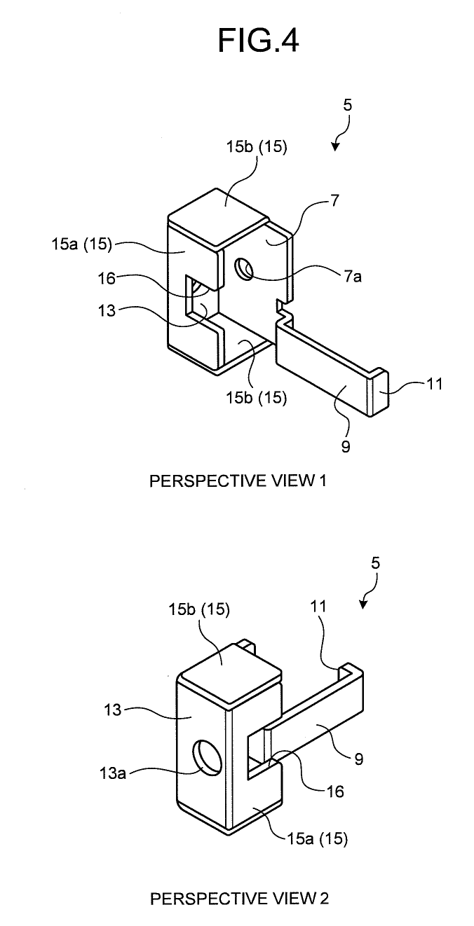

FIG. 4 includes external perspective views showing a schematic configuration of the switch-lock fitting 5. The switch-lock fitting 5 is intended to fix the locker switch 3 in an off state. The switch-lock fitting 5 is configured to include a fixing portion 7, a movement restricting portion 9, a rotation restricting portion 11, an erecting portion 13, and a locking-unit restricting portion 15.

The fixing portion 7 is intended to fix the switch-lock fitting 5 on the switch mounting surface 2a. The fixing portion 7 has a thin plate shape. A screw hole 7a is formed in the fixing portion 7. By screwing a screw 19 into the fixation hole 4 through the screw hole 7a, the fixing portion 7 is screw-fixed and the switch-lock fitting 5 can be secured on the switch mounting surface 2a. The fixing portion 7 is screw-fixed at one side of the locker switch 3 along the longitudinal direction of the locker switch 3.

The movement restricting portion 9 has a thin plate shape and is formed integrally with the fixing portion 7. In a state where the switch-lock fitting 5 is fixed on the switch mounting surface 2a, the movement restricting portion 9 is made to be able to restrict the advancing and retracting movement of the locker switch 3 by covering a retracted portion of the locker switch 3 in the off state, that is, the other end 3b. By restricting the advancing and retracting movement of the locker switch 3, the power source can be prevented from being switched to the on state. While the movement restricting portion 9 covers the other end 3b in the retracted state of the locker switch 3, the one end 3a in the advanced state can be viewed and accordingly the on or off state can be easily confirmed.

The rotation restricting portion 11 is an end of the movement restricting portion 9 and is formed by folding an end opposite to the fixing portion 7 toward the switch mounting surface 2a. In a state where the switch-lock fitting 5 is fixed on the switch mounting surface 2a, the rotation restricting unit 11 abuts one side surface of the locker switch 3 substantially perpendicular to the switch mounting surface 2a. In the first embodiment, a switch frame 3c that is formed to surround the locker switch 3 stands out from the switch mounting surface 2a (also see FIG. 2). The rotation restricting portion 11 abuts one side surface of the out-standing switch frame 3c. This prevents the switch-lock fitting 5 from rotating around the screw hole 7a formed in the fixing portion 7. By preventing rotation of the switch-lock fitting 5, the movement restricting portion 9 is prevented from being displaced from a position in which the other end 3b of the locker switch 3 is covered with the portion 9, so that the locker switch 3 can be fixed in the off state more reliably.

The erecting portion 13 has a thin plate shape, and it is formed on an end of the fixing portion 7, which is opposite to the movement restricting portion 9, and provided substantially perpendicularly to the surface where the screw hole 7a is formed. A locking hole 13a is formed in the erecting portion 13. A bar unit 17a of a locking unit 17 such as a padlock or a latch lock (hasp lock) is passed through the locking hole 13a to achieve locking.

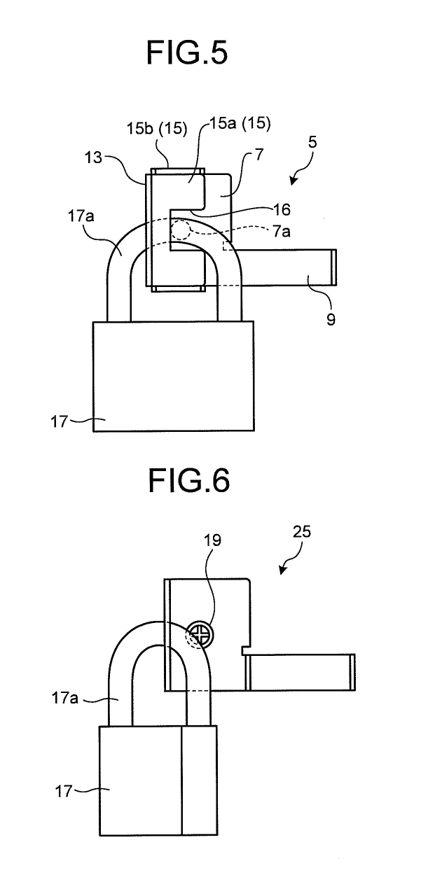

FIG. 5 is a front view of the switch-lock fitting in a state where the locking unit 17 is locked. When the bar unit 17a is passed through the locking hole 13a to lock the locking unit 17, the bar unit 17a can be positioned in front of the screw 19 that fixes the switch-lock fitting 5 as shown in FIG. 5. Therefore, when the locking unit 17 is locked, access to the screw 19 can be prohibited. Because the access to the screw 19 can be restricted by the locking unit 17, only a person having a key for unlocking the locking unit 17 can remove the screw 19 and perform switching of the locker switch 3. For example, if an operator who performs a maintenance check of a control target locks the locking unit 17, then it is hard for persons other than the operator to make switching of the locker switch 3, thereby ensuring safety of the operator.

The locking-unit restricting portion 15 is intended to restrict a posture of the locking unit 17 locked in the switch-lock fitting 5, thereby placing the bar unit 17a in front of the screw 19 more reliably. The locking-unit restricting portion 15 includes a facing portion 15a and closing portions 15b. The facing portion 15a is formed by folding a front portion of the erecting portion 13 to be opposed to the surface of the fixing portion 7 where the screw hole 7a is formed. The facing portion has an opening 16 formed in a location opposed to the screw hole 7a of the fixing portion 7, thereby allowing access to the screw 19 in a state where the locking unit 17 is not locked. This enables fastening or removal of the screw 19 by use of a tool or the like. The closing portions 15b are formed to close a gap formed between the fixing portion 7 and the facing portion 15a on both sides sandwiching the bar unit 17a passing through the locking hole 13a.

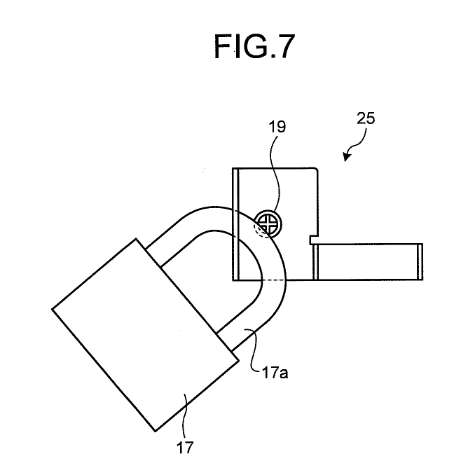

FIGS. 6 and 7 are front views of a switch-lock fitting 25 in which the locking-unit restricting unit is not formed, as a comparative example. When the facing unit is not formed in the switch-lock fitting 25, the screw 19 can be accessed from the front with circumventing the bar unit 17a by situating the locking unit 17 in a posture shown in FIG. 6, so that the switch-lock fitting 25 can be removed. When the closing portion 15b is not formed in the switch-lock fitting, the screw 19 can be accessed from the front with circumventing the bar unit 17a by situating the locking unit 17 in a posture shown in FIG. 7, so that the switch-lock fitting 25 can be removed.

On the other hand, the switch-lock fitting 5 described in the first embodiment restricts a posture of the locking unit 17 with the locking-unit restricting portion 15 (the facing portion 15a and the closing portion 15b). Therefore, detachment of the switch-lock fitting 5 at a timing unintended by a person who has attached the switch-lock fitting 5 can be prevented more reliably while avoiding the states as shown in FIGS. 6 and 7. This configuration further enhances the safety of the operator during a maintenance check.

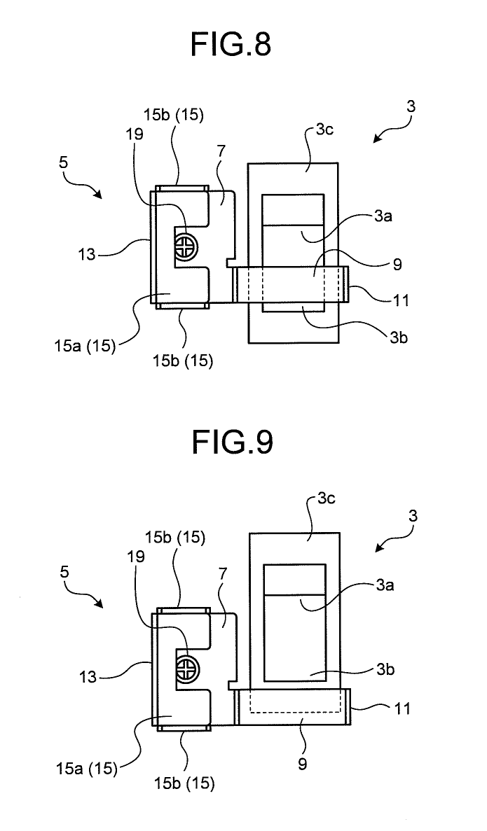

FIG. 8 is an enlarged partial front view of a state where the switch-lock fitting 5 is screw-fixed using the on/off-fixing fixation hole 4a. FIG. 9 is an enlarged partial front view of a state where the switch-lock fitting 5 is screw-fixed using the on/off-releasing fixation hole 4b.

When the switch-lock fitting 5 is screw-fixed using the on/off-fixing fixation hole 4a as shown in FIG. 8, the movement restricting portion 9 can be situated in the position in which the other end 3b of the locker switch 3 that is in the retracted state is covered therewith. Therefore, the locker switch 3 can be fixed in the off state by screw-fixing the switch-lock fitting 5 using the on/off-fixing fixation hole 4a.

When the switch-lock fitting 5 is screw-fixed using the on/off-releasing fixation hole 4b as shown in FIG. 9, the movement restricting portion 9 can be situated in a position away from the position in which the other end 3b of the locker switch 3 that is in the retracted state is covered with. Therefore, the locker switch 3 is made to be switchable between the on and off states by screw-fixing the switch-lock fitting 5 using the on/off-releasing fixation hole 4b. Even when the locker switch 3 is made to be switchable between the on and off states, the switch-lock fitting 5 can be fixed near the locker switch 3, so that the risk of loss of the switch-lock fitting 5 can be reduced.

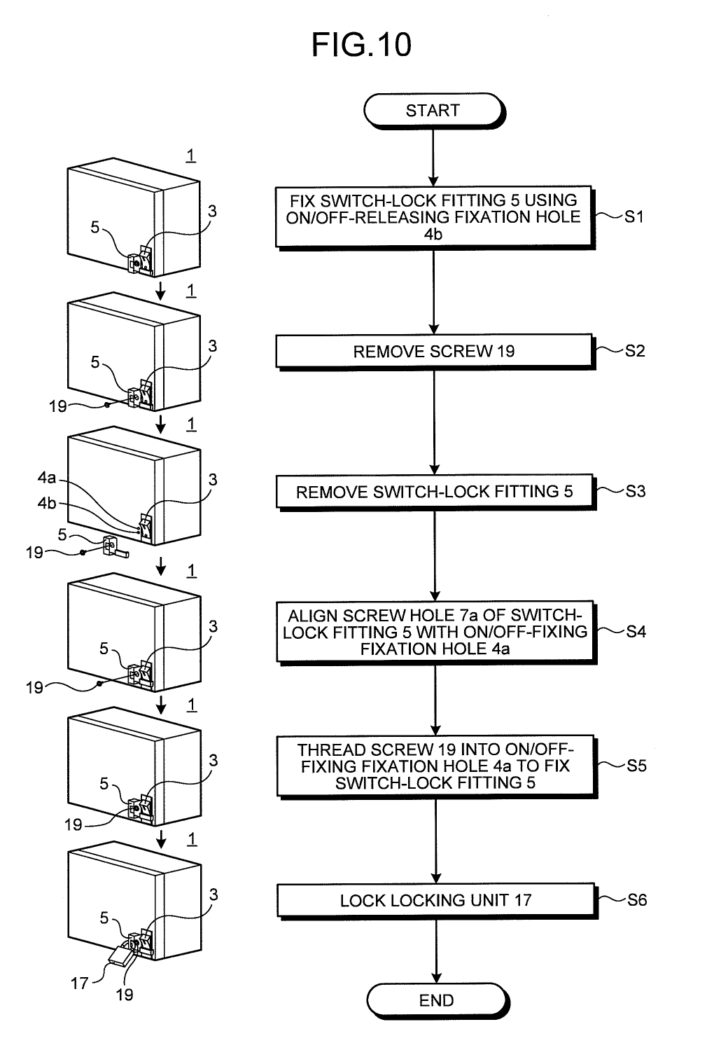

FIG. 10 is a chart showing a procedure of fixing the locker switch 3 in the off state using the switch-lock fitting 5. The switch-lock fitting 5 is at first fixed on the switch mounting surface 2a using the on/off-releasing fixation hole 4b (Step S1). The screw 19 is removed (Step S2) and the switch-lock fitting 5 is removed (Step S3). The screw hole 7a of the switch-lock fitting 5 is then aligned with the on/off-fixing fixation hole 4a (Step S4) and the screw 19 is screwed into the on/off-fixing fixation hole 4a (Step S5) to secure the switch-lock fitting 5 on the switch mounting surface 2a. The locking unit 17 is finally locked (Step S6) to prevent the switch-lock fitting 5 from being removed.

In this way, when the switch-lock fitting 5 is fixed using the on/off-releasing fixation hole 4b during normal use of the control device 1, an operator who performs a maintenance check for a control target or the like can perform the operation in a state where the safety is ensured by fixing the locker switch 3 in the off state without bothering to bring the switch-lock fitting 5 with him/her.

Although only one screw hole 7a is formed in the fixing portion 7 in the first embodiment, a plurality of screw holes 7a may of course be formed. When a plurality of screw holes 7a are formed, and plural screws are used to fix the switch-lock fitting 5 on the switch mounting surface 2a, rotation of the switch-lock fitting 5 can be prevented.

### Second Embodiment

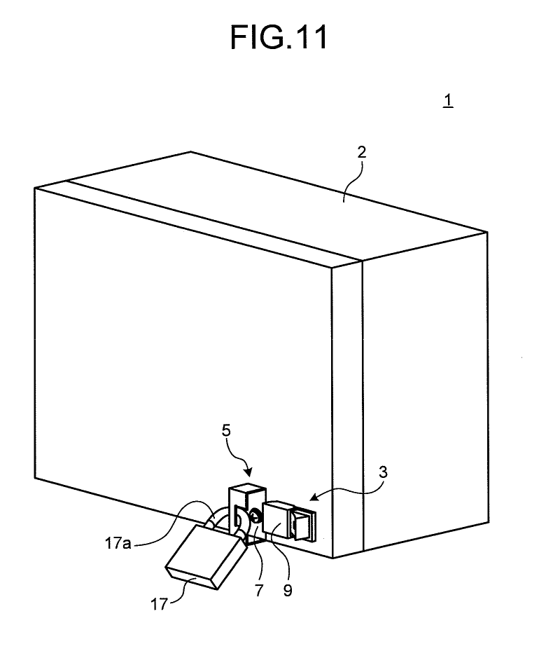

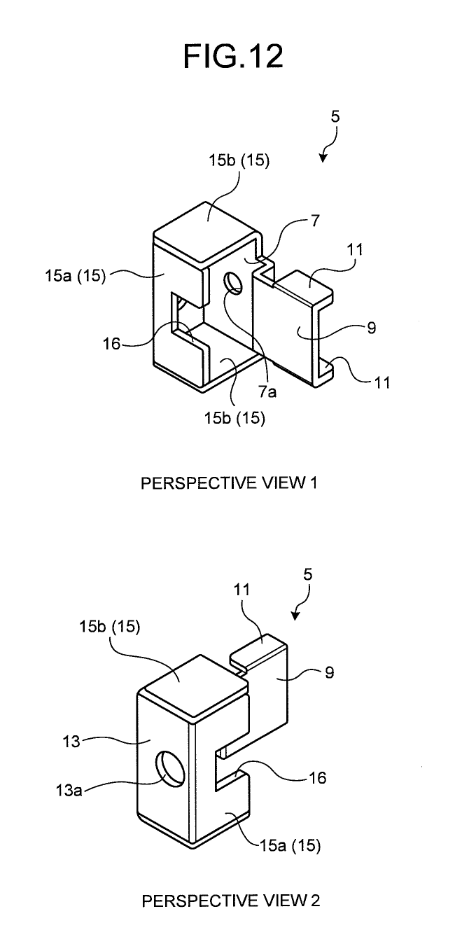

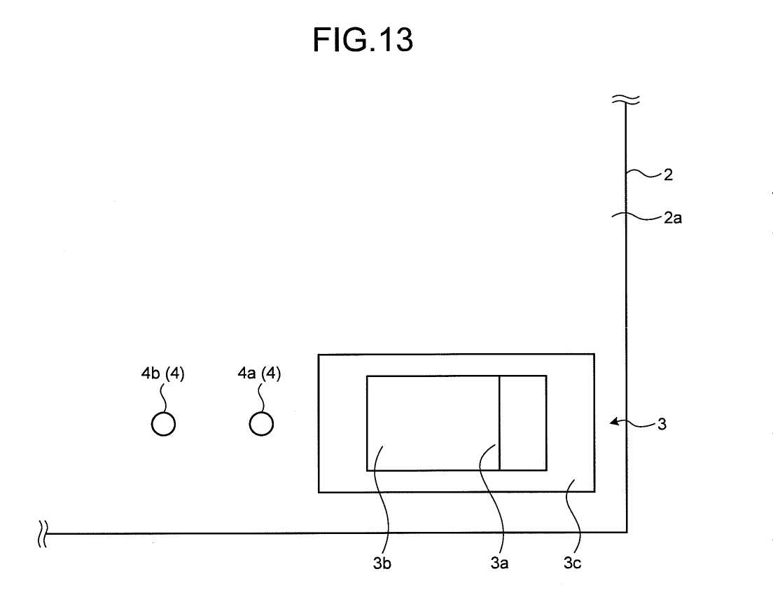

FIG. 11 is an external perspective view showing a schematic configuration of a control device including a switch-lock fitting according to a second embodiment of the present invention. FIG. 12 include external perspective views showing a schematic configuration of the switch-lock fitting. FIG. 13 is an enlarged partial front view of part of a locker switch on the switch mounting surface 2a. Constituent elements equivalent to those in the first embodiment are denoted by the same reference symbols and detailed description thereof will be omitted.

In the second embodiment, the fixing unit 7 of the switch-lock fitting 5 is fixed to one side of the locker switch 3 along short side direction of the switch 3. As shown in FIG. 13, the on/off-fixing fixation hole 4a and the on/off-releasing fixation hole 4b are formed to one side of the locker switch 3 along a short side direction of the switch 3 to be juxtaposed with each other.

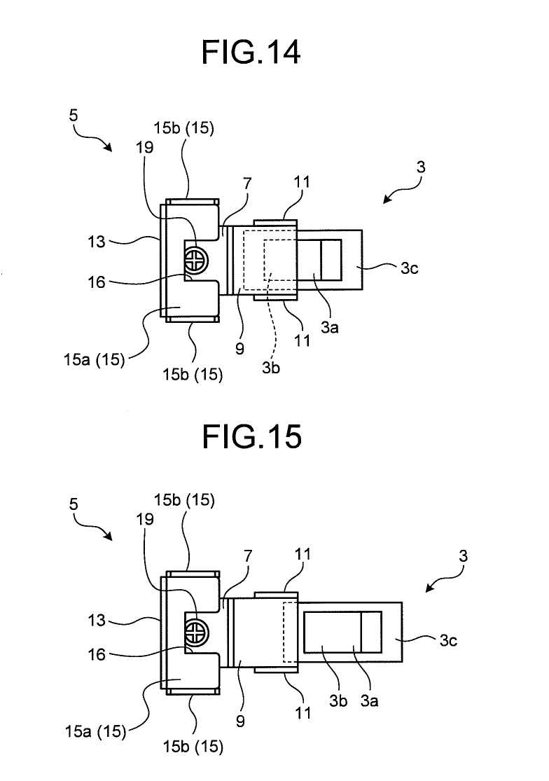

FIG. 14 is an enlarged partial front view of a state where the switch-lock fitting 5 is screw-fixed using the on/off-fixing fixation hole 4a. FIG. 15 is an enlarged partial front view of a state where the switch-lock fitting 5 is screw-fixed using the on/off-releasing fixation hole 4b.

When the switch-lock fitting 5 is screw-fixed using the on/off-fixing fixation hole 4a as shown in FIG. 14, the movement restricting portion 9 can be situated in a position in which the other end 3b of the locker switch 3 that is in the retracted state is covered therewith. Therefore, the locker switch 3 can be fixed in the off state by screw-fixing the switch-lock fitting 5 using the on/off-fixing fixation hole 4a.

When the switch-lock fitting 5 is screw-fixed using the on/off-releasing fixation hole 4b as shown in FIG. 15, the movement restricting portion 9 can be situated in a position away from the position in which the other end 3b of the locker switch 3 that is in the retracted state is covered therewith. Therefore, as in the first embodiment, the locker switch 3 can be switched between the on and off states by screw-fixing the switch-lock fitting 5 using the on/off-releasing fixation hole 4b. Furthermore, even when the locker switch 3 is made to be switchable between the on and off states, the switch-lock fitting 5 can be fixed near the locker switch 3, so that the risk of loss of the switch-lock fitting 5 can be reduced.

In this way, by changing a type of the switch-lock fitting 5 or formation positions of the fixation holes 4, the movement restricting portion 9 is caused to cover the retracted portion of the locker switch 3 according to a position where the locker switch 3 is installed, a shape of the box 2 or the like, thereby making it possible to fix the locker switch 3 in the off state.

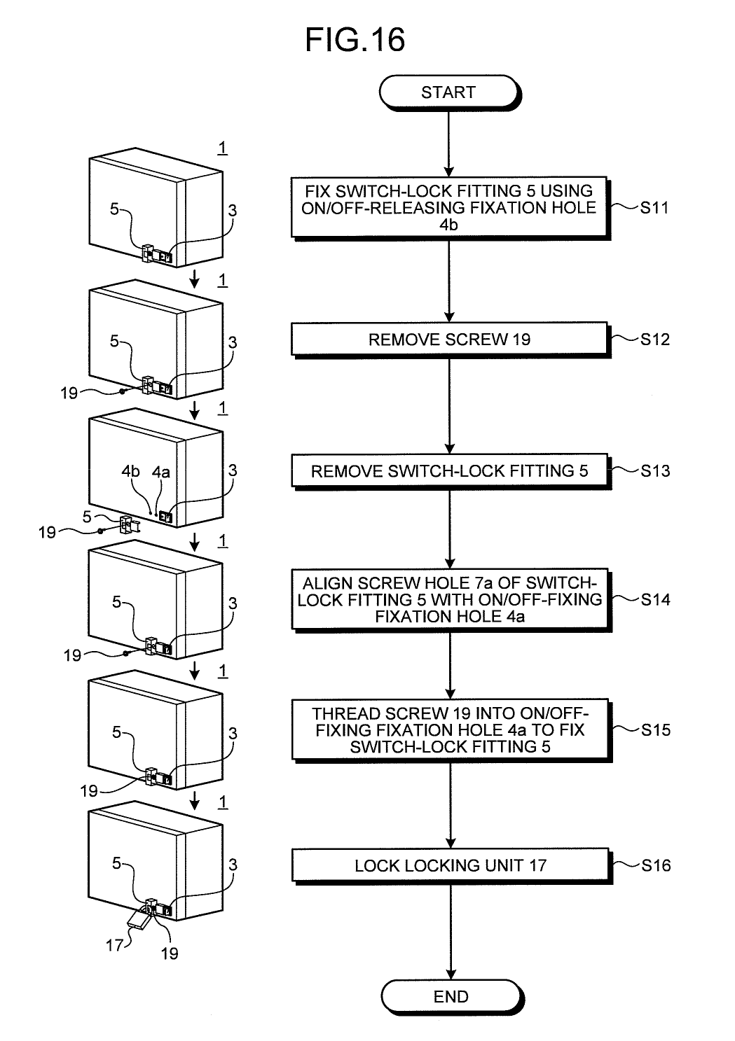

FIG. 16 is a chart showing a procedure of fixing the locker switch 3 in the off state using the switch-lock fitting 5. The switch-lock fitting 5 is at first fixed on the switch mounting surface 2a using the on/off-releasing fixation hole 4b (Step S11). The screw 19 is removed (Step S12) and the switch-lock fitting 5 is removed (Step S13). The screw hole 7a of the switch-lock fitting 5 is then aligned with the on/off-fixing fixation hole 4a (Step S14) and the screw 19 is screwed into the on/off-fixing fixation hole 4a (Step S15) to fix the switch-lock fitting 5 on the switch mounting surface 2a. The locking unit 17 is finally locked (Step S16) to prevent the switch-lock fitting 5 from being removed.

While the case in which the locker switch 3 is fixed in the off state has been given as an example in the above embodiments, the present invention is not limited thereto. For example, the switch-lock fitting 5 can be configured to cover the one end 3a of the locker switch 3, thereby fixing the locker switch 3 in the on state. The switch-lock fitting 5 may also be configured to be selectively fixed in a position where the movement restricting portion 9 covers the one end 3a or in a position where the movement restricting portion 9 covers the other end 3b. In this case, a user or an operator who performs a maintenance check is enabled to choose whether the locker switch 3 is to be fixed in the on state or the off state according to the situation in question.

### INDUSTRIAL APPLICABILITY

As described above, the switch-lock fitting according to the present invention is useful for fixing an on/off state of a locker switch, and is particularly suitable for fixing an on/off state of a power source of a control device that controls a target to be controlled.

### REFERENCE SIGNS LIST

1 CONTROL DEVICE
2 BOX
2a SWITCH MOUNTING SURFACE
3 LOCKER SWITCH
3a ONE END
3b OTHER END
3c SWITCH FRAME
4 FIXATION HOLE
4a ON/OFF-FIXING FIXATION HOLE
4b ON/OFF-RELEASING FIXATION HOLE
5 SWITCH-LOCK FITTING
7 FIXING PORTION
7a SCREW HOLE
9 MOVEMENT RESTRICTING PORTION
11 ROTATION RESTRICTING PORTION
13 ERECTING PORTION
13a LOCKING HOLE
15 LOCKING-UNIT RESTRICTING PORTION
15a FACING PORTION
15b CLOSING PORTION
16 OPENING
17 LOCKING UNIT
17a BAR UNIT
19 SCREW
25 SWITCH-LOCK FITTING

1-6. (canceled)

7. A switch-lock fitting comprising:
a fixing portion that has a screw hole formed therein for screw-fixing the fixing portion on a switch mounting surface on which a locker switch having both ends that alternately perform advancing and retracting movements is mounted;
a movement restricting portion that can restrict the advancing and retracting movements of the locker switch by covering a retracted portion of the locker switch in a state where the fixing portion is fixed on the switch mounting surface;
an erecting portion that is provided to erect substantially perpendicularly to a surface in which the screw hole is formed; and
a locking-unit restricting portion that restricts access to a screw screw-fixing the fixing portion,
wherein the erecting portion has a locking hole formed therein, that enables a bar unit of a locking unit to pass therethrough to achieve locking, and
the locking-unit restricting portion restricts a posture of the locking unit locked in the locking hole to situate the bar unit in front of the screw thereby to restrict access to the screw.

8. The switch-lock fitting according to claim 7, further comprising a rotation restricting portion that is formed on the movement restricting portion and restricts rotation of the switch-lock fitting by abutting one side surface of the locker switch which is substantially perpendicular to the switch mounting surface, wherein the side surface is provided on a switch frame that surrounds the locker switch.

9. The switch-lock fitting according to claim 7, wherein the locking-unit restricting portion includes:
a facing portion that faces the surface in which the screw hole of the fixing portion is formed; and
closing portions that close a gap formed between the fixing portion and the facing portion on both sides sandwiching the bar unit that passes through the locking hole,
wherein the facing portion has an opening formed therein in a location opposed to the screw hole.

10. A control device comprising:
the switch-lock fitting according to claim 7;
a locker switch that has both ends alternately perform advancing and retracting movements; and
a switch mounting surface on which the locker switch is mounted, wherein
a plurality of fixation holes for screw-fixing the fixing portion of the switch-lock fitting are formed in the switch mounting surface,
the fixing portion is screw-fixed on the switch mounting surface using one of the fixation holes to fix the movement restricting portion of the switch-lock fitting in a position in which a retracted portion of the locker switch is covered with the movement restricting portion, thereby restricting the advancing and retracting movements of the locker switch, and
the fixing portion is screw-fixed on the switch mounting surface using the other one of the fixation holes to fix the movement restricting portion in a position away from the position in which the retracted portion of the locker switch is covered with the movement restricting portion, thereby allowing the advancing and retracting movements of the locker switch.
